(19) United States
(12) Patent Application Publication
(10) Pub. No.: US 2012/0122670 A1
(43) Pub. Date: May 17, 2012

(54) Sulfur tolerant alumina catalyst support

(75) Inventors: Andrew Polli, Washington Crossing, PA (US); Francis Francis, Columbia, MD (US); Thomas English, Parkesburg, PA (US); Rui Miguel Jorge Coelho Marques, Paris (FR); Olivier Larcher, Pennington, NJ (US)

(73) Assignee: RHODIA OPERATIONS, Aubervilliers (FR)

(21) Appl. No.: 13/373,519

(22) Filed: Nov. 16, 2011

Related U.S. Application Data
(60) Provisional application No. 61/458,034, filed on Nov. 16, 2010.

(51) Int. Cl. B01J 21/12; B01J 21/14

(52) U.S. Cl. 502/263; 502/439

(57) ABSTRACT

The present invention is directed to a method for making a sulfur tolerant alumina, that includes the steps of: forming aluminum hydrate from one or more water soluble aluminum salts, said salts each comprising an aluminum cation or aluminum anion and an oppositely charged counterion, in an aqueous medium, contacting the aluminum hydrate with a silica precursor in the aqueous medium and in the presence of counterions of the one or more aluminum salts, isolating silica precursor-contacted aluminum hydrate particles from the aqueous medium, and calcining the silica precursor-contacted aluminum hydrate particles to form particles of the sulfur tolerant alumina.

### FIELD OF THE INVENTION

This invention relates to a method for making a sulfur tolerant alumina, suitable for application as a catalyst support in treating of exhaust products from internal combustion engines, especially diesel engines.

### BACKGROUND OF THE INVENTION

The exhaust products of internal combustion engines are known health hazards to human beings, animals as well as plant life. The pollutants are, in general, non-burnt hydrocarbons, carbon monoxide, nitrogen oxides, as well as residual amounts of sulfur and sulfurous compounds. Exhaust catalysts have to meet stringent requirements with respect to light-off performance, effectiveness, long-term activity, mechanical stability as well as cost effectiveness in order to be suitable for vehicle application. The pollutants of non-burnt hydrocarbons, carbon monoxides as well as nitrogen oxides have been successfully treated by contact with multifunctional, noble metal catalysts which are capable of converting a high percentage of the pollutants into less harmful products of carbon dioxide, water (steam) and nitrogen. However, the sulfur and sulfurous compounds present in fuels and, in turn, in exhaust product, have been known to poison the noble metals resulting in lessening their catalytic effectiveness and life.

The “catalytic converter” used to convert the harmful pollutants into non-harmful gases, usually consists of three components, that is, the catalytically active metal, the support on to which the active metal is dispersed, and a substrate on to which the support is applied or “washcoated”.

The catalytic metals that are useful to cause effective conversion of harmful pollutants, like carbon monoxide, nitrogen oxides, and non-burnt hydrocarbons under the varying conditions encountered, are noble metals, usually the metals of the platinum group, such as platinum, palladium, rhodium and mixtures thereof. These noble metal catalysts are well known in the art and are more fully described in, for example, DE 05 38 30 318.

The noble metal is typically supported on high surface area inorganic oxides, such as high surface area alumina particles. The high surface area alumina is applied or “washcoated” onto a ceramic or metallic substrate, such as in the form of a honeycomb monolith or wire mesh or the like structure. It is also possible to apply the noble metals onto the support after washcoating the support material onto the monolith.

Nanocrystalline alumina is used as a catalyst support due to its high specific surface area and good thermal resistance to coarsening and sintering at elevated temperatures. However, alumina undergoes a strong interaction with sulfur and sulfurous compounds present in fuels and, in turn, in exhaust product, which results in the storage of SO⁴⁻ at the surface of alumina. When so adsorbed, the sulfurous compounds are known to poison noble metal catalysts, especially those formed with platinum metal, causing reduction in activity and effective life of the catalyst system.

Silica has little interaction with sulfur and sulfurous compounds and does not show the ability to storage sulfate. However, silica does not exhibit the hydrothermal stability required to form effective emission control catalyst supports and, therefore, is not a desirable catalyst support material for such applications. As such, it has been found to be desirable to modify the alumina surface with silica in order to combine the structural characteristics of alumina and chemical characteristics of silica.

WO 2008/045175 discloses a structure comprising a porous alumina particulate having silica cladding on its surface made by forming an alumina particulate into an aqueous slurry, mixing a silica precursor material with the slurry, treating the mixture with acid to form an aqueous suspension of treated alumina particles, washing the suspension to remove alkali metal materials, spray drying the suspension to provide dry particles, and then and calcining the dry particles to form a high surface area alumina having silica cladding on its surface.

It is desired to form an alumina catalyst support that is capable of enhancing the activity of noble metals in the conversion of carbon monoxide and hydrocarbon materials to carbon dioxide and water while exhibiting high tolerance to the presence of sulfur and sulfurous compounds by a simpler process.

It is further desired to form an alumina catalyst support capable of enhancing the activity of noble metals, especially platinum metal, to convert noxious emission products of internal combustion engines, especially diesel engines, to more environmentally benign products and to exhibit such activity over an extended life because of its enhance tolerance to the presence of sulfur and sulfurous compounds and to provide improved properties compared to prior alumina catalyst support materials.

### SUMMARY OF THE INVENTION

The present invention is directed to a method for making a sulfur tolerant alumina, comprising:

forming aluminum hydrate from one or more water soluble aluminum salts, said salts each comprising an aluminum cation or aluminum anion and an oppositely charged counterion, in an aqueous medium,

contacting the aluminum hydrate with a silica precursor in the aqueous medium and in the presence of counterions of the one or more aluminum salts,

isolating silica precursor-contacted aluminum hydrate particles from the aqueous medium, and

calcining the silica precursor-contacted aluminum hydrate particles to form particles of the sulfur tolerant alumina.

The method of the present invention for making a sulfur tolerant alumina provides a simple precipitation process to prepare silica cladded alumina having a silica-rich surface, as determined by FT-IR, probe molecule adsorption, or any other relevant technique and exhibiting good resistance to sulfur poisoning.

The sulfur tolerant alumina made by the method of the present invention is suitable as a support for forming support for noble metal catalysts. The supported noble metal catalysts exhibit resistance to sulfur poisoning and, therefore, are useful in applications directed to internal combustion engine emission conversion. The chief advantage of the current process is its extreme simplicity compared to the state of the art, in that the silica cladding is carried out using hydrated aluminum oxide in the same aqueous medium in which the hydrated aluminum oxide is synthesized, without isolation of the hydrated aluminum oxide from the aqueous medium and without removing impurities, such as ionic impurities, from the aqueous medium.

The sulfur tolerant alumina made by the method of the present invention provides a highly desired support for noble metal catalyst application. The resultant catalyst product exhibits enhanced activity in treating noxious emission products of internal combustion engines, especially diesel engines while having an extended active period due to its enhanced tolerance to sulfur and sulfurous products.

A sulfur tolerant composite oxide comprising alumina, silica, and zirconia and exhibiting improved phase stability wherein, after calcining at 1050° C. for 2 hours, the zirconia is present as tetragonal zirconia only.

A sulfur tolerant composite oxide comprising alumina, silica, and TiO₂, and exhibiting improved phase stability wherein, after calcining at 900° C. for 2 hours, the TiO₂ is present as anatase TiO₂ only.

### BRIEF DESCRIPTION OF THE DRAWINGS

FIG. 1 shows a logarithmic derivative plot of pore size distribution for the calcined (1050° C./2 h) powder of the composite oxide of Example 1.

FIG. 2 shows cumulative pore volume as a function of the pore diameter for calcined (1050° C./2 h) powder of the composite oxide of Example 2.

FIG. 3 shows logarithmic derivative pore size distribution for calcined (1050° C./2 h) powder of the composite oxide of Example 2.

FIG. 4 shows the logarithmic derivative pore size distribution for a calcined (900° C./2 h) powder of the composite oxide of Example 3.

FIG. 5 shows a X-Ray diffractogram for calcined (900° C./2 h) powder of the composite oxide of Example 3.

FIG. 6 shows a X-Ray diffractogram for calcined (1050° C./2 h) powder of the composite oxide of Example 3.

FIG. 7 shows a logarithmic derivative pore size distribution for calcined (900° C./2 h) powder of the composite oxide of Example 4.

FIG. 8 shows a X-Ray diffractogram for calcined (750° C./2 h) powder of the composite oxide of Example 4.

FIG. 9 shows a X-Ray diffractogram for calcined (900° C./2 h) powder of the composite oxide of Example 4.

### DETAILED DESCRIPTION OF THE INVENTION

The present invention is directed to an improved method for making an alumina support for forming noble metal catalysts that is useful in forming an exhaust catalyst having increased tolerance to the presence of sulfur normally found in emission product streams of internal combustion engines and the like and, thereby, achieves lower poisoning of the noble metal of the resultant catalyst than with catalysts utilizing conventionally formed supports.

The support of the present invention is generally in the form of particulate comprising alumina having a cladding of silica thereon.

The following terms, used in the present description and the appended claims, have the following definitions:

The term “particulate” refers to shaped particles in the form of powder, beads, extradite, and the like. In this teaching, it is used in reference to cores, supports as well as the resultant supported noble metal products.

The term “alumina” refers to any of the forms of aluminum oxide alone or as a mixture with small amounts of other metal and/or metal oxides.

The term “silica-clad” refers to the silica-rich surface of the high surface area alumina particulate of the present invention.

The term “adsorbed” or “adsorption” shall refer collectively to the phenomena of adsorption (the ability to hold or concentrate gases, liquid or dissolved substances on the surface of the adsorbent, e.g. alumina), and absorption (the ability to hold or concentrate gases, liquids or dissolved substances throughout the body of the absorbent, e.g. alumina), in each case either by chemical reaction, which may be ionic, covalent, or of mixed nature, or by physical forces.

The term “sulfurous material” refers to sulfur, sulfur oxides and compounds containing sulfur atoms.

In one aspect, the present invention is directed to a method for making a sulfur tolerant high surface area alumina particulate having a silica cladding thereon and to a sulfur tolerant high surface area alumina particulate having a silica cladding thereon (each referred to a “sulfur tolerant alumina” or “silica-clad alumina”).

It has now been found that alumina particulate can be clad with silica to provide a support that exhibits a high tolerance to the presence of sulfurous materials and, thereby, provides a catalyst having an extended useful life for emission control. The formation of silica clad alumina particulate has been accomplished by the application of certain specific combination of process parameters, as fully described herein below.

As referred to herein, an aqueous medium is a medium comprising water and which may optionally further comprise one or more water soluble organic solvents such as for example, lower alcohols, such as ethanol, lower glycols, such as ethylene glycol, and lower ketones, such as methyl ethyl ketone.

Hydrated aluminum oxide, such as, for example, boehmite, gibbsite, or bayerite, or a mixture thereof, is formed in an aqueous medium. The hydrated aluminum oxide can be formed in the aqueous medium from water soluble aluminum salts by a variety of known methods, such as, for example, by adding ammonium hydroxide to an aqueous solution of an aluminum halide, such as aluminum chloride, or by reacting aluminum sulfate with an alkali metal aluminate, such as sodium aluminate, in the aqueous medium. Suitable water soluble aluminum salts comprise an aluminum cation, such as Al³⁺, and a negatively charged counterion or an aluminum-containing anion, such as Al(OH)₄⁻, and a positively charged counterion. In one embodiment, the water soluble water aluminum salts comprise one or more water soluble aluminum salts that each independently comprise an aluminum cation and a negatively charged counterion, such as, for example aluminum halide salts or aluminum sulfate salts. In another embodiment, the water soluble aluminum salts comprise one or more water soluble aluminum salts that each independently comprise an aluminum anion and a positively charged counterion, such as for example, water soluble alkali metal aluminate salts. In another embodiment, the water soluble aluminum salts comprise one or more water soluble aluminum salts that each independently comprise an aluminum cation and a negatively charged counterion, and one or more water soluble aluminum salts that each independently comprise an aluminum anion and a positively charged counterion.

In one embodiment, a water soluble aluminum precursor is introduced into the reactor in the form of an aqueous solution of the water soluble aluminum precursor. The acidity of such aluminum precursor solution can optionally be adjusted over a wide range, through addition of acid or base. For example, an acid, such as nitric acid, chloridric acid, sulfuric acid, or a mixture thereof, may be added to increase the acidity of an aluminum sulfate or aluminum chloride solution or a base, such as sodium hydroxide, potassium hydroxide or a mixture thereof, may be added to decrease the acidity of a sodium aluminate solution. In one embodiment, the acidity of the aluminum precursor solution is adjusted prior to introduction of the precursor solution into the reactor by adding acid to the aluminum precursor solution. In one embodiment, the acidity of the aluminum precursor solution is adjusted prior to introduction of the precursor solution into the reactor by adding base to the aluminum precursor solution

In one embodiment, aluminum hydrate seeds are first formed at an acidic pH in a very dilute aqueous system and more aluminum hydrate is then deposited on the seed crystals at a pH of from about 7 to about 8.

In one embodiment, aluminum hydrate seeds are formed by reacting aluminum sulfate and sodium aluminate in an aqueous medium at a pH of from about 2 to about 5 in a reaction vessel and more aluminum hydrate is deposited on the seeds by simultaneously feeding aqueous streams of aluminum sulfate and sodium aluminate into the reaction vessel while allowing the pH of the aqueous medium to gradually increase to a pH of from about 7 to about 10, more typically from about 7 to about 8. The temperature of the aqueous medium during formation of aluminum hydrate is typically in the range of from about 30° C. to about 100° C., more typically from about 50° C. to about 100° C.

In one embodiment, precipitation of particles of aluminum hydrate from the aqueous medium is continued, typically by allowing the pH of the aqueous medium to increase to about 8 to 10, more typically from about 8.5 to about 9.5, to form a slurry of aluminum hydrate particles suspended in the aqueous medium. In one embodiment, wherein an aluminum hydrate is formed by simultaneously feeding streams of aqueous aluminum sulfate and aqueous sodium aluminate to the reaction vessel, the particles of aluminum hydrate may be precipitated by discontinuing the feed of the aluminum sulfate stream, while continuing the feed of the sodium aluminate stream and allowing the pH of the reaction medium to increase with the continued addition of sodium aluminate to the reaction vessel. Sodium hydroxide or any alkali solution could be used also to increase the pH of the solution. The amount of aluminum hydrate particles formed is typically in the range of from about 3 to about 50 parts by weight (“pbw”) of hydrated aluminum oxide particles per 100 pbw of the slurry. The temperature of the aqueous medium during precipitation of aluminum hydrate particles is typically in the range of from about 30° C. to about 100° C., more typically from about 50° C. to about 100° C. The aqueous medium in which the aluminum hydrate is formed contains the counterions of the water soluble aluminum salts from which the aluminum hydrate is made.

The particles of aluminum hydrate are contacted with a water soluble silica precursor in the aqueous medium. The aluminum hydrate may be formed prior to introduction of the silica precursor (or may be formed simultaneously with introduction of the silica precursor). Suitable silica precursor compounds include, for example, alkylsilicates, such as tetramethylorthosilicate, silicic acids, such as metasilicic acid or orthosilicic acid, and alkali metal silicates such as sodium silicate or potassium silicate. More typically the silica precursor is selected from alkali metal silicates and mixtures thereof. Even more typically, the silica precursor comprises sodium silicate.

In one embodiment, a water soluble silica precursor is introduced into the reactor in the form of an aqueous solution of the water soluble silica precursor. The pH of such silica precursor solution can optionally be adjusted within a wide range, through addition of acid or base. For example, nitric, chloridric, or sulfuric acid can be added to decrease the pH of an alkali metal silicate solution to a desired value and sodium hydroxide or potassium hydroxide can be added to increase the pH of a silicic acid solution to a desired value. In one embodiment, the silica precursor solution is neutralized to a pH of about 7 prior to introduction of the precursor solution into the reactor by adding acid to an initially basic silica precursor solution, or through adding base to an initially acidic silica precursor solution.

In one embodiment, a stream of aqueous sodium silicate is fed into the reaction vessel and mixed with an aqueous slurry of aluminum hydrate particles to contact the sodium silicate with the particles. The temperature of the aqueous medium during addition of the source of silica ions is typically in the range of from about 30° C. to about 100° C., more typically from about 50° C. to about 100° C.

The contacting of the aluminum hydrate with the silica precursor material is conducted in the aqueous medium and in the presence of the counterions of the one or more water soluble aluminum salts. In one embodiment, one or more species of negatively charged counterions, such as halide anions or sulfate anions, are present in the aqueous medium. In one embodiment, one or more species of positively charged counterions, such as alkali metal cations, are present in the aqueous medium. In one embodiment, one or more species of negatively charged counterions and one or more species of positively charged counterions are each present in the aqueous medium.

The silica precursor material may be introduced in a batch mode or in a continuous mode. In one embodiment of a batch mode process, the charge of silica precursor is introduced to a reaction vessel containing the aluminum hydrate and aqueous medium while the contents of the reaction vessel are mixed. (In another embodiment of a batch mode process, the charge of silica precursor is introduced to a reaction vessel simultaneously with the charge of water soluble aluminum salts and the contents of the reaction vessel are mixed). In one embodiment of a continuous process, a stream of an aqueous suspension of aluminum hydrate a and stream of an aqueous solution of silica precursor are simultaneously fed to an in-line mixing device.

The amount of silica precursor used to contact the aluminum hydrate should be sufficient to provide a silica clad alumina product having from a silica content of from about 1 to about 40 pbw silica (SiO₂), more typically from about 5 to about 30 pbw silica per 100 pbw of the silica clad alumina. Typically, the silica precursor is introduced to the aqueous medium in the form of an aqueous stream comprising from about 1 to about 40, more typically from about 3 to about 30 pbw, more typically from about 4 to 25 pbw silica, as SiO₂, per 100 pbw of the aqueous stream of silica precursor. In one embodiment, the silica precursor is water soluble and the aqueous stream of silica precursor is an aqueous solution of the silica precursor. In one embodiment, the aqueous stream of silica precursor further comprises one or more surfactants to facilitate dispersal of the silica precursor in the aqueous feed stream. Typically, the aqueous stream of silica precursor is heated prior to introduction into the reaction vessel to a temperature substantially the same as that of the aqueous medium within the reaction vessel, but preheating is not required.

In one embodiment, the mixture of suspended aluminum hydrate particles and silica precursor is heated to a temperature above ambient temperature, more typically to a temperature of from about 50° C. to about 200° C. for a time period of from about 20 minutes to about 6 hours, more typically from about 20 minutes to about 1 hour. For temperatures greater than 100° C., the heating is conducted in a pressure vessel at a pressure of greater than atmospheric pressure.

The particles of silica precursor-contacted particles of aluminum hydrate are then isolated from the aqueous medium, typically by filtration. In one embodiment, prior to isolation of the particles from the aqueous medium, the pH of the suspension of silica precursor-contacted aluminum hydrate particles in the aqueous medium is adjusted to a pH of from about 4 to about 10, by the introduction of acid, typically an acid comprising nitric acid, sulfuric acid, or acetic acid, to the suspension.

In one embodiment, the particles of silica precursor-contacted aluminum hydrate are washed to remove water soluble residues from the particles, including, in the case where the alumina is made from an alkali metal aluminate and/or the silica precursor is an alkali metal silicate alkali metal residues, of the forming, precipitating, and contacting steps. In one embodiment, prior to isolation of the particles from the aqueous medium, one or more water soluble salts are added to the suspension of silica precursor-contacted aluminum hydrate particles in the aqueous medium in order to improve washing efficiency. Suitable water soluble salts include, for example, ammonium sulfate, ammonium hydroxide, ammonium carbonate, potassium carbonate, sodium carbonate, aluminum bicarbonate, and mixtures thereof.

The washing may be conducted using hot water and/or an aqueous solution of a water-soluble ammonium salt such as, for example, ammonium nitrate, ammonium sulfate, ammonium hydroxide, ammonium carbonate, potassium carbonate, sodium carbonate, ammonium bicarbonate, and the like or mixtures thereof. In one embodiment of the washing step, the slurry of silica precursor-contacted aluminum hydrate particles is dewatered, then washed with an aqueous solution of water-soluble ammonium salt, then dewatered, then washed with water, and then dewatered again to form a wet cake of washed silica clad aluminum hydrate particles.

In one embodiment, the wet cake of washed particles of silica precursor-contacted aluminum hydrate particles is re-dispersed in water to form a second aqueous slurry.

In one embodiment, the second aqueous slurry is then spray dried to form particles of silica precursor-contacted aluminum hydrate. In another embodiment, the pH of the second aqueous slurry is adjusted to a pH of from about 4 to about 10, more typically of from about 6 to about 8.5, by the introduction of acid, such as the acids mentioned above in regard to adjustment of the pH of the suspension of particles of silica precursor-contacted aluminum hydrate in the aqueous medium, or of base, such as sodium hydroxide, to the second aqueous slurry. In one embodiment, the pH adjusted second slurry is then heated to a temperature above ambient temperature, more typically to a temperature of from about 50° C. to about 200° C., even more typically to a temperature of from about 80° C. to about 200° C. for a time period of from about 20 minutes to about 6 hours, more typically from about 20 minutes to about 1 hour. For temperatures greater than 100° C., the heating is conducted in a pressure vessel at a pressure of greater than atmospheric pressure. The particles of silica precursor-contacted of aluminum hydrate of the pH adjusted second slurry are then isolated from the aqueous medium of the second slurry. In one embodiment, the particles of silica precursor-contacted aluminum hydrate are isolated from the second slurry are redispersed in water to form a third aqueous slurry and the third aqueous slurry is spray dried.

The isolated or the isolated, redispersed, and spray dried particles of silica precursor-contacted aluminum hydrate are then calcined to form the desired silica-clad alumina product. In one embodiment, the silica precursor-contacted aluminum hydrate particles are calcined at elevated temperature, typically from 400° to 1100° C., for greater than or equal to about 30 minutes, more typically from about 1 to about 5 hours, to form the silica-clad alumina product. The calcination can be conducted in air, or nitrogen, optionally in the presence of up to about 20% water vapor. Unless otherwise indicated, the specific calcination conditions described herein refer to calcination in air.

In one embodiment, the particles of silica precursor-contacted aluminum hydrate are calcined at greater than or equal to 400° C., more typically from about 600 to about 1100° C. for greater than or equal to 1 hour, more typically from about 2 to about 4 hours, to form a silica-clad alumina.

The silica-clad alumina of the present invention may, optionally, be doped with conventional dopants, such as transition metals and metal oxides, alkaline earth metal and metal oxides, rare-earths and oxides, and mixtures thereof. A dopant, when used, is normally present in small amounts, such as from 0.1 to 20, typically from 1 to 15 weight percent, based on the amount of alumina. Such dopants are used in alumina materials to impart particular properties, such as hydrothermal stability, abrasion strength, catalytic activity promotion and the like, to the alumina materials, as is well known in the art.

Suitable dopants include transition metals, such as, for example yttrium, zirconium, and titanium, as well as oxides thereof, alkaline earth metals, such as, for example, beryllium, magnesium, calcium, and strontium, as well as oxides thereof, and rare earth elements, such as, for example, lanthanum, cerium, praseodymium, and neodymium, as well as oxides thereof. A given dopant is typically introduced to the sulfur tolerant alumina of the present invention by adding a dopant precursor, typically a water soluble salt of the desired dopant, to the reaction vessel during the above described formation of the hydrated aluminum oxide portion of sulfur tolerant alumina. Suitable dopant precursors include, for example, rare earth chlorides, rare earth nitrates, rare earth acetates, zirconium nitrate, zirconium oxychloride, zirconium sulfate, nitrates, rare earth acetates, zirconium nitrate, zirconium oxychloride, zirconium sulfate, zirconium orthosulfate, zirconium acetate, zirconium lactate, zirconium ammonium carbonate, titanium chloride, titanium oxychloride, titanium acetate, titanium sulfate, titanium lactate, titanium isopropoxide, cerous nitrate, ceric nitrate, cerous sulfate, ceric sulfate, ceric ammonium nitrate, and mixtures thereof.

Dopants can also be introduced as a colloidal dispersion in a solvent, the solvent might contain additional ions for dispersion stabilization. To ensure good stability of the dopant colloidal suspension and to obtain high dispersion of the dopant within the alumina body, the size of the colloids is preferably between 1 and 100 nm. The solution may contain simultaneously the dopant in the form of colloidal particles and ionic species.

In one embodiment, a dopant is introduced by adding a dopant precursor, typically in the form of an aqueous solution of the dopant precursor, either as a separate feed stream or by mixing the dopant precursor solution with one of the feed containing aluminum precursor, to the reaction vessel during formation of the hydrated aluminum hydrate particles.

In another embodiment, a dopant is introduced by adding a dopant precursor, typically in the form of an aqueous solution of the dopant precursor, to the reaction vessel after formation of the hydrated aluminum oxide particles. In this case, it the pH of the aqueous slurry of hydrated aluminum oxide particles is typically adjusted to a pH of from about 4 to about 9 with acid, such as nitric acid, sulfuric acid, or acetic acid, prior to the addition of the dopant precursor solution. The dopant precursor solution is then added to the reaction vessel under continuous agitation. After this addition is complete, the pH is generally adjusted to a pH of from about 6 to about 10 by addition of a base, such as, ammonium hydroxide or sodium hydroxide.

In one embodiment, the sulfur tolerant alumina of the present invention comprises, based on 100 pbw of the composition, from about 1 to about 30 pbw, more typically from about 5 to about 20 pbw, of a dopant selected from rare earths, Ti, Zr, and mixtures thereof more typically selected from La, Ce, Zr, Ti, and mixtures thereof.

In one embodiment, a sulfur tolerant alumina according to the present invention is a composite oxide comprising alumina, silica, and zirconia that exhibits improved phase stability wherein, after calcining at 1050° C. for 2 hours, the zirconia is present as tetragonal zirconia only, that is, unexpectedly, no significant amount of monoclinic zirconia is detectable by X-ray diffraction.

In one embodiment, a sulfur tolerant alumina according to the present invention is a composite oxide comprising alumina, silica, and TiO₂, that exhibits improved phase stability wherein, after calcining at 900° C. for 2 hours, the TiO₂ is present as anatase TiO₂ only, that is, unexpectedly, no significant amount of rutile TiO₂ is detectable.

The sulfur tolerant alumina made by the method of the present invention is a high surface area alumina particulate having silica cladding on substantially the entire surface area. Unlike prior silica treated alumina products produced by conventional impregnation techniques, the present resultant product retains its high surface area and pore volume properties (thus, showing that the present clad product does not result in deposition which cause bridging of the pores to result in pore blockages). Further, infra-red spectrum analysis of the silica clad alumina particulate shows attenuation of adsorption peak associate with the Al—OH bond relative to the untreated alumina and the appearance of silanol groups. This is indicative silica cladding present on the surface of the alumina particulate material.

The above described method for making a sulfur tolerant alumina has been found to unexpectedly achieve a support product having resistance to sulfur adsorption while retaining hydrothermal stability. Surprisingly, it has been found that the contacting of the aluminum hydrate particles with the silica precursor may be conducted in the same aqueous medium in which the aluminum hydrate particles are formed and precipitated, without first isolating the aluminum hydrate particles or otherwise separating the aluminum hydrate particles from the residues, such as alkali metal residues, of the forming and precipitating steps.

The sulfur tolerant alumina of the present invention typically exhibit a high (BET) surface area of at least about 20 m²/g, such as from about 20 to about 500 m²/g, typically from about 75 to 400 m²/g and more typically from 100 to 350 m²/g. The silica-clad alumina particulate typically exhibit a pore volume of at least about 0.2 cc/g, such as from 0.2 to 2 cm³/g and typically from 0.5 to 1.2 cm³/g and an average pore diameter within the range of 50 to 1000 Angstroms, typically from 100 to 300 Angstroms. Such high surface area particulate provides ample surface area for deposition of a noble metal catalyst and having it readily contacted with the emission stream to provide effective catalytic conversion of the noxious products to more benign emission products.

The sulfur tolerant alumina of the present invention has good resistance to sulfur uptake. The uniformity and continuity of coverage of silica on the sulfur tolerant alumina embodiment of the present invention can shown through, for example, FTIR or measurement of zeta potential and can be inferred the effectiveness and efficiency of the support product to resist sulfur uptake.

The sulfur tolerant alumina of the present invention may be in the form of powder (preferred) having a average particle size of from about 1 to 200 micrometers (“μm”), typically from 10 to 100 μm, or beads having an average particle size of from 1 millimeter (“mm”) to 10 mm. Alternately, the alumina particulate can be in the form of pellets or extradite (e.g. cylindrical shape). The size and particular shape being determined by the particular application contemplated.

The sulfur tolerant alumina of the present invention, especially when in the form of a powder of from 1 to 200 μm, more typically from 10 to 100 μm, can be further used as a catalytic coating on a low surface area substrate. The substrate structure can be chosen from a variety of forms for a particular application. Such structural forms include monoliths, honeycomb, wire mesh and the like. The substrate structure is normally formed of a refractory material such as, for example, alumina, silica-alumina, silica-magnesia-alumina, zirconia, mullite, cordierite, as well as wire mesh and the like. Metallic honeycomb substrates can also be used. The powder is slurried in water, peptized by the addition of a small amount of acid (typically mineral acids), and then subjected to milling to cause a reduction in particle size suitable for washcoating application. The substrate structure is contacted with the milled slurry, such as by dipping the substrate into the slurry. The excess material is removed, such as by application of blown air, followed by calcining the coated substrate structure to cause adhesion of the (wash-coat) silica clad high surface area alumina particulates of the present invention to adhere to the substrate structure.

Noble metals, usually the metals of the platinum group, such as platinum, palladium, rhodium and mixtures thereof, can be applied in manners well known to those skilled in this art either before wash-coating the silica clad alumina particulate using a suitable conventional noble metal precursor (acidic or basic), or after washcoating by dipping the washcoated substrate in a suitable noble-metal precursor solution (either acidic or basic). More typically the alumina or sulfur tolerant alumina of the present invention is formed, followed by application of the noble metal thereto, and finally, to wash-coating the alumina supported catalyst material onto a substrate.

Additional functionality can be provided by mixing the sulfur tolerant alumina of the present invention with other oxide supports like alumina, magnesia, ceria, ceria-zirconia, rare-earth oxide-zirconia mixtures etc, and then wash-coating these products onto a substrate. The resultant catalyst can be directly loaded into canisters and the like either alone or in combination with other materials as part of the exhaust emission system of an internal combustion engine. Thus, the exhaust products, which normally comprise oxygen, carbon monoxide, carbon dioxide, hydrocarbons, nitrogen oxides, sulfur, sulfurous compounds and sulfur oxides, are passed through the exhaust system to provide contact with the noble-metal supported catalyst. The result provides conversion of the noxious and harmful exhaust products into more environmentally acceptable materials. When using a catalyst formed with a support of the present invention, one achieves a catalyst system having extended active term and of higher overall activity than would be achieved with catalysts having supports either with no silica or with silica-alumina formed from conventional co-precipitation or impregnation techniques.

It has been found that the sulfur tolerant alumina of the present invention is useful as a support for noble-metal catalysts, which exhibit enhanced sulfur tolerance in comparison to supports having the same silica content formed by conventional impregnation or co-precipitation methods. It is well known that petroleum feed used in forming light (gasoline) and moderate (diesel) weight fuels contain sulfur and sulfur containing compounds (e.g. thiophenes and the like) as part of the feed material. Although efforts have been made to remove sulfurous materials, this is increasingly difficult to achieve with respect to fuel product streams of higher molecular weights (e.g. diesel fuels). Thus, sulfurous materials are known to be present in hydrocarbon fuels, especially in diesel fuels. The sulfurous materials present in the emission stream of hydrocarbon fuel-burning engines are known to be adsorbed by alumina and certain dopants which, in turn, cause poisoning of the noble metal residing on the support surface. The unexpected high tolerance (lack of adsorption) to sulfur that is achieved by the silica clad alumina support of the present invention permits the formation of desired catalyst for effectively treating emission product streams of internal combustion engines, especially diesel fuel engines.

The following examples are given as specific illustration of the claimed invention. It should be understood, however, that the invention is not limited to the specific details set forth in the examples. All parts and percentages in the examples and in the remainder of the specification are by weight unless otherwise specified.

Further, any range of numbers recited in the specification or claims, such as representing a particular set of properties, units of measure, conditions, physical states or percentages, is intended to literally incorporate expressly herein by reference or otherwise, any number falling within such range, including any subset of numbers within any range so recited.

### Examples 1 and 2 and Comparative Examples C₁-C₄

The composite oxide of Example 1 comprising, on the basis of 100 pbw of the composite oxide, 80 pbw Al₂O₃ and 20 pbw SiO₂, was made using aluminum sulfate, sodium aluminate, and sodium silicate as follows. Solution A was an aqueous solution of aluminum sulfate, with a concentration of 8.31 wt % expressed as aluminum oxide Al₂O₃. Solution B was an aqueous solution of sodium aluminate, with a concentration of 24.86 wt %, expressed as aluminum oxide Al₂O₃. Solution C was an aqueous solution of sodium silicate, with a concentration of 29.21 wt %, expressed as silicium oxide SiO₂. A 1 liter reactor was filled with 424 g of deionized water. The reactor contents were heated at 65° C. and, except as specifically noted below, this temperature was maintained along the whole experiment. 6.02 g of Solution A were introduced in the reactor under agitation over 5 minutes. The contents of the reactor were then stirred for 5 minutes without further addition of solution A. Solutions A and B were then simultaneously fed to the reactor with agitation of the reactor contents. Over the 5 first minutes of the simultaneous feeds, the respective flow rates of Solutions A and B were adjusted so the pH of the slurry increased from 3 to 7.3 during the 5 minutes. The flow rate of Solution B was then decreased until the pH is stabilized at pH 7.3. With pH stabilized at pH 7.3, Solutions A and B are added continuously over 30 minutes. After these 30 minutes at pH 7.3, the feed of Solution A is stopped and the pH of the reactor contents was allowed to increase with continued fed of Solution B. 10 minutes after discontinuing the feed of Solution A, the feed of Solution B was stopped, at which point the reactor contents exhibited a pH of 9 and a total amount of 143 g of Solution A and a total amount of 113 g Solution B had been fed to the reactor. The reactor contents were then heated to 95° C. 34.2 g of Solution C were then fed to the reactor, with continued agitation of the reactor contents. The reactor contents were then cooled to 65° C., filtered, and washed with deionized water at 60° C. to form a wet filter cake. The volume of wash water was equivalent to the volume of aqueous medium in the reactor. A solution is prepared dissolving 120 g of ammonium bicarbonate per liter of water and heated to 60° C. The wet filter cake was washed with a volume of the ammonium bicarbonate solution corresponding to the volume of aqueous medium in the reactor and then washed with the same volume of deionized water at 60° C. The resulting wet filter cake was then dispersed in deionized water to obtain a slurry containing about 10 wt % of solids. The slurry was then spray dried to obtain a dried powder. The spray dried powder was then calcined at different temperatures. Specific Surface Areas (“SA”), expressed in square meters per gram (“m²/g”)), Pore Volume (expressed in cubic centimeters per gram (“cm³/g”)) and Average Pore Diameter (expressed in nanometers (“nm”)) were measured and are reported in TABLE I below as a function of the initial calcination temperature (expressed in degrees Centigrade (“° C.”)) and time (expressed in hours (“h”)).

Unless specified, pore size distributions, pore volume, pore diameter and BET surface areas are given by mean of Nitrogen adsorption technique. Data are collected on a Micromeretics Tristar 3000 apparatus. Pore size distribution and pore volume data are collecting using 91 measurement points between P/P0=0.01 and P/P0=0.998.

Mercury pore size distribution are collected on a Micromeretics Autopore Apparatus with 103 measurement points between 0.5 psia and 30,000 psia

TABLE I

| Calcination | SA | Pore volume | Average pore |
|---|---|---|---|
| temperature/time | (m²/g) | (cm³/g) | diameter (nm) |
| 400° C./1 h | 500 | 1.3 | 6.5 |
| 750° C./2 h | 400 | 1.55 | 12 |
| 1050° C./2 h | 285 | 1.2 | 12.7 |

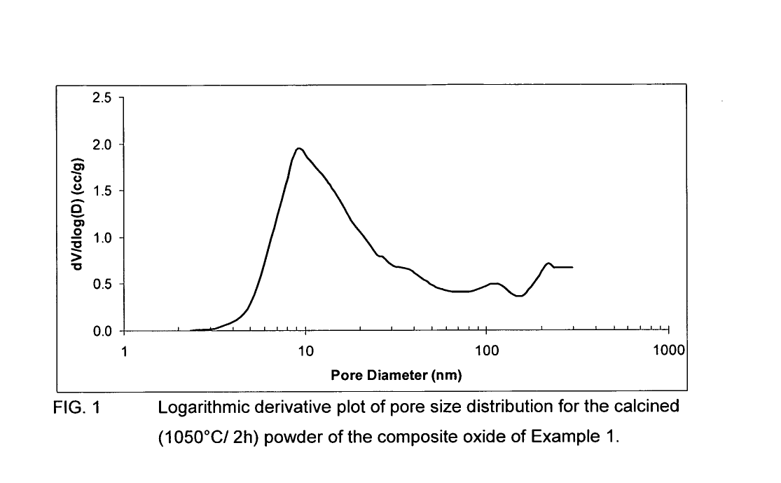

After calcination at 1050° C. for 2 hours, the composite oxide of Example 1 was then calcined at higher temperature. Specific Surface Areas (“SA”, in square meters per gram), Pore Volume (in cubic centimeters per gram) and Average Pore diameter (in nanometers) are reported in TABLE II below for each of two different secondary calcination temperatures (in degrees Centigrade (“° C.”)) and times (in hours (“h”)). A derivative log plot of pore size distribution after calcination at 1050° C. for 2 hours is shown in FIG. 1.

TABLE II

| Calcination | SA | Pore volume | Average pore |
|---|---|---|---|
| Temperature (° C.)/time (h) | (m²/g) | (cm₃/g) | diameter (nm) |
| 1150° C./4 h | 119 | 0.64 | 16.9 |
| 1200° C./2 h | 110 | 0.7 | 24 |

The zeta potential of the oxide of Example 1, calcined at 1050° C. for 2 hours at pH 6.5, was found to be −35 millivolts (“mV”), whereas zeta potential measured in the same conditions for pure alumina is 10 mV and zeta potential of pure silica is −43 mV, which clearly shows the substantial impact of the silica at the surface of alumina on surface charge.

The composite oxide of Example 2 comprising, on the basis of 100 pbw of the composite oxide, 90 pbw Al₂O₃ and 10 pbw SiO₂, was made as in Example 1, except that the reactor was maintained at 65° C. throughout the reaction and was not heated at 95° C. before addition of sodium silicate solution. After spray drying, the powder was calcined at 1050° C. for 2 hours. Specific Surface Areas (“SA”), expressed in square meters per gram (“m²/g”)), Pore Volume (expressed in cubic centimeters per gram (“cm³/g”)) and Average Pore Diameter (expressed in nanometers (“nm”)) were measured and are reported in TABLE III below for that calcination temperature (expressed in degrees Centigrade (“° C.”)) and time (expressed in hours (“h”)).

TABLE III

| Calcination | SA | Pore volume | Average pore |
|---|---|---|---|
| Temperature/time | (m²/g) | (cm³/g) | diameter (nm) |
| 1050° C./2 h | 256 | 1.26 | 13.8 |

After subsequent calcination at 1200° C. for 2 hour, surface area of the powder was found to be 116 m²/g.

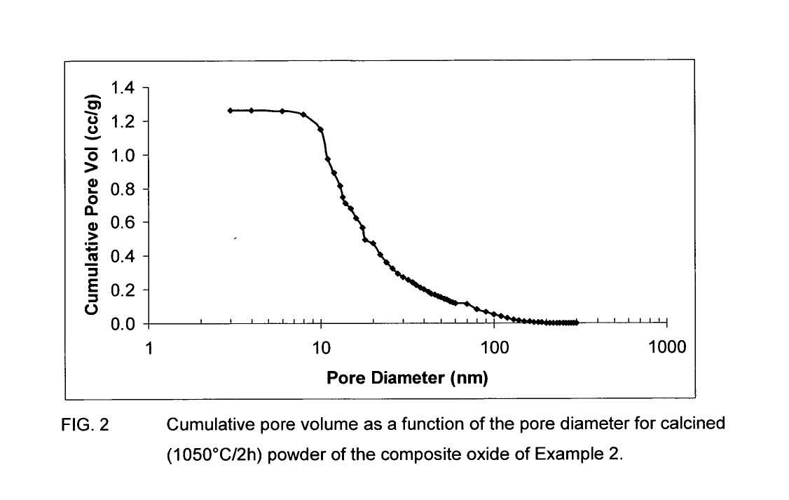

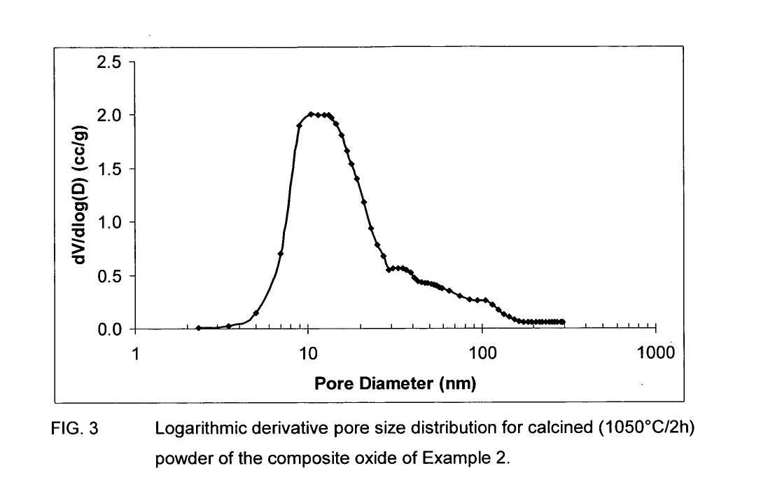

FIG. 2 shows cumulative pore volume as a function of the pore diameter and for calcined (1050° C./2 h) powder of the composite oxide of Example 2 and FIG. 3 shows logarithmic derivative pore size distribution for calcined (1050° C./2 h) powder of the composite oxide of Example 2.

The oxide composition of Comparative Example C1 contained Al₂O₃/La₂O₃/SiO₂ in a ratio of 87.3/3.6/9.1% wt as oxide and was made according to the process described in Example 4 of US Patent Application Publication No. US2007/019799. After spray drying, an initial calcination was conducted at 1050° C. for 2 hours.

Comparative Example C2 was a commercially available gamma alumina (Rhodia MI-307) and Comparative Example C3 was a commercially available lanthanum doped gamma alumina (MI-386 alumina, Rhodia Inc.).

The oxide composition of Comparative Example C4 contained Al₂O₃/SiO₂ in a ratio of 90/10% wt as oxide and was made according to the process described in Example 5 of U.S. Patent Application Publication No. US2007/019799. After spray drying, an initial calcination was conducted at 1050° C. for 2 hours

Bi metallic Platinum/palladium model catalysts were prepared from the oxide powders of Example 1, and Comparative Examples C1, C2, C3 and C4 by impregnation of the respective oxide powder by the incipient wetness method using a tetraamine platinum(II) hydroxide solution and tetraamine palladium (II) hydroxide to target 1 wt % total metal respective to the oxide and a weight ratio Pt/Pd of 1/1. The fresh model catalysts are dried at 120° C. overnight and then calcined in air at 500° C. for 4 hours.

Hydrothermal ageing treatments were carried out on the model catalysts under simulated engine exhaust redox conditions in an atmosphere containing 10 vol % O₂, 10 vol % H₂O, and balance N₂, at 750° C. for 16 hours. Sulfation treatments were conducted on hydrothermally aged model catalysts in an atmosphere containing 20 vpm SO₂, 10 vol % O₂,10 vol % H₂O, and balance N₂ at 300° C. for 12 hours. The loadings of elemental sulfur on the sulfated model catalysts were then determined by chemical analysis and are reported as specific sulfur loading, in units of weight percent sulfur per square meter of sulfated model catalyst surface area (“wt % sulfur/m²”) in Table IV below.

TABLE IV

| | | Specific surface | | Specific S |
|---|---|---|---|---|
| | | area (m²/g), | % wt | loading (10² |
| Oxide | Oxide | after Aging at | sulfur | wt % |
| Ex# | Composition | 750° C./16 h | Sulfated | sulfur/m²) |
| 1 | Al₂O_{3/}SiO₂ 80/20 | 234 | 0.74 | 0.31 |
| 2 | Al₂O_{3/}SiO₂ 90/10 | 257 | 0.79 | 0.37 |
| C1 | Al₂O₃/SiO2/La2O3 | 164 | 1.04 | 0.63 |
| | 87.3/3.6/9.1 | | | |
| C2 | Al₂O_{3/}La₂O₃ 96/4 | 121 | 1.10 | 0.91 |
| C3 | Al₂O₃ | 110 | 1.2 | 1.09 |
| C4 | Al₂O₃/SiO2 90/10 | 145 | 0.6 | 0.41 |

The results demonstrate the high sulfation resistance of the silica-clad aluminum oxide of the present invention.

Testing of powder model catalysts prepared with powders from Example 2 and comparative example C1 and C4 was carried out on a synthetic gas bench (FIG. 2) in light-off mode. The catalyst (20 mg of active phase+150 mg of SiC) was put in a quartz U-shaped down-flow reactor (having a length of 255 mm and an internal diameter of 5 mm) and the temperature is increased at the rate of 10° C./min to 450° C. The gas composition, generated by independent mass flow controllers, was lean with CO and HC (richness=0.387) and is given in Table V below.

TABLE V
Richness (r) and gas composition in vol %

| Gas composition | Lean CO/HC |
|---|---|
| (vol %) | (r = 0.387) |
| O₂ | 13.00 |
| CO₂ | 5.00 |
| H₂O | 5.00 |
| CO | 0.200 |
| H₂ | 0.06 |
| C₃H₆ | 0.050 |
| C₃H₈ | 0.050 |
| NO | 0.015 |
| N₂ | Balance |

The catalysts were activated during a first light-off experiment, with the complete gas feed up to 450° C. Catalysts were then cooled to 150° C. under lean model gas and conversions were measured during the second light-off run.

The temperatures, in degrees Centigrade (“° C.”), at which conversion of CO reached 10%, 50% and 90% of the total amount of CO are listed as T10, T50, and T90, respectively, in TABLE VI below.

TABLE VI

| Oxide | Oxide | T10 | T50 | T90 |
|---|---|---|---|---|
| Ex# | Composition | (° C.) | (° C.) | (° C.) |
| 2 | Al₂O_{3/}SiO₂ 90/10 | 175 | 180 | 190 |
| C1 | Al₂O₃/SiO2/La2O3 | 185 | 195 | 200 |
| | 87.3/3.6/9.1 | | | |
| C4 | Al₂O₃/SiO2 90/10 | 185 | 190 | 195 |

The results shows the improved CO oxidation performance of the catalyst comprising the composite oxide of Example 2, as compared to analogous catalysts comprising the composite oxides of Comparative Examples C1 and C4.

### Example 3

The composite oxide of Example 3 comprising, on the basis of 100 pbw of the composite oxide, 65 pbw Al₂O₃, 20 pbw SiO₂ and 15 pbw ZrO2 was made as in Example 2, except that zirconium nitrate (concentration 21.3%, density 1.306) was mixed with aluminum sulfate solution prior to precipitation. The spray dried powder exhibited a surface area of 459 m²/g. The spray dried powder was calcined at 900° C. for 2 hour and 1050° C. for 2 hours. Results of surface area, pore volume are reported in TABLE VII below. Specific Surface Areas (“SA”), expressed in square meters per gram (“m²/g”)), Pore Volume (expressed in cubic centimeters per gram (“cm³/g”)) and Average Pore Diameter (expressed in nanometers (“nm”)) were measured and are reported in TABLE VII below for each of the two calcination temperatures (expressed in degrees Centigrade (“° C.”)) and time (expressed in hours (“h”)).

TABLE VII

| Calcination | SA | Pore volume | Average pore |
|---|---|---|---|
| Temperature/time | (m²/g) | (cm³/g) | diameter (nm) |
| 900° C./2 h | 294 | 1.17 | 11.0 |
| 1050° C./2 h | 182 | 0.89 | 13.4 |

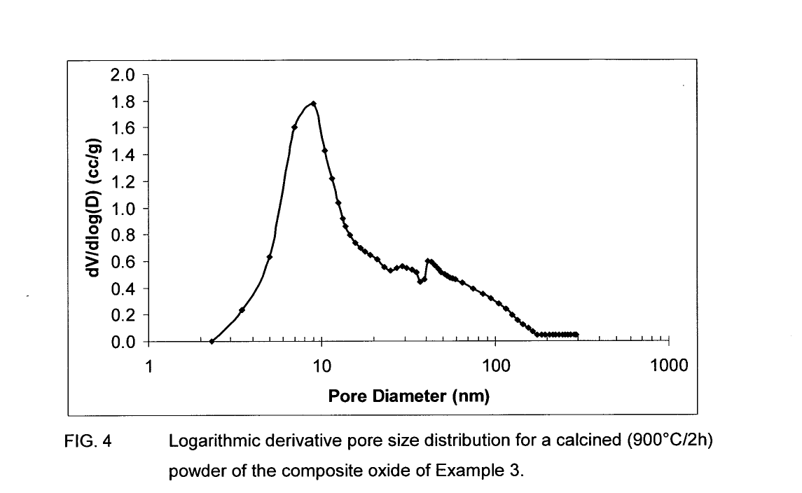

FIG. 4 shows the logarithmic derivative pore size distribution for a calcined (900° C./2 h) powder of the composite oxide of Example 3.

X-Ray diffraction data was collected between 2⊖=1⊖ and 2⊖=9⊖ for the two calcined powders. Only tetragonal zirconia was visible. Crystallite size for the zirconia was evaluated using the Debye Sherrer method and results are reported in TABLE VIII below as ZrO₂ crystallite size in nanometers (nm) for each of the two calcination temperatures.

TABLE VIII

| Calcination | ZrO₂ Crystallite |
|---|---|
| Temperature/time | size (nm) |
| 900° C./2 h | 3 |
| 1050° C./2 h | 7 |

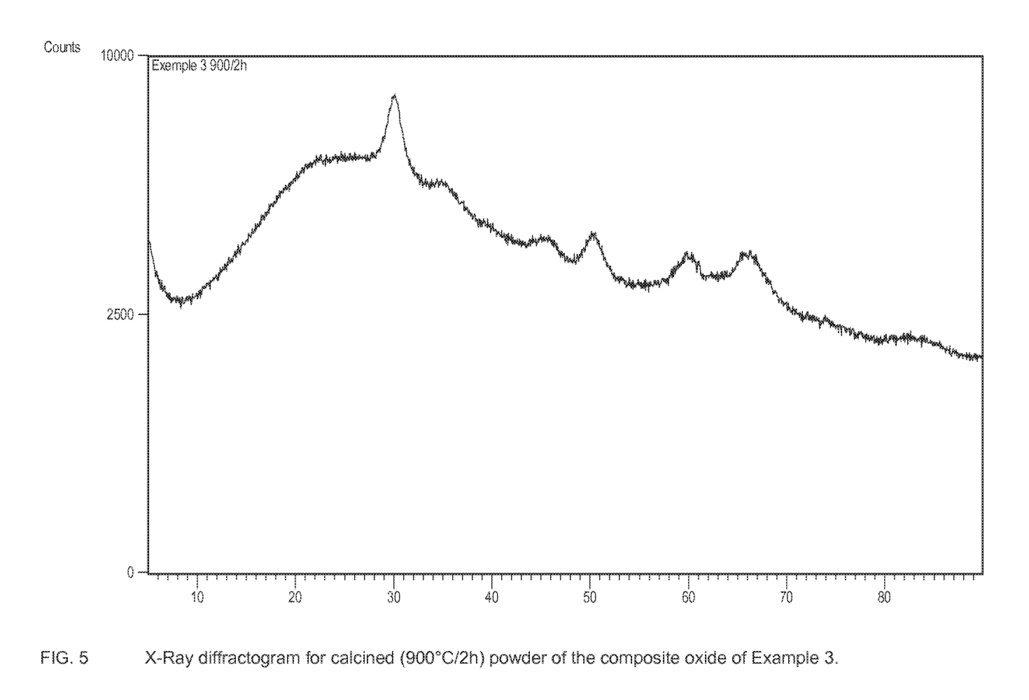

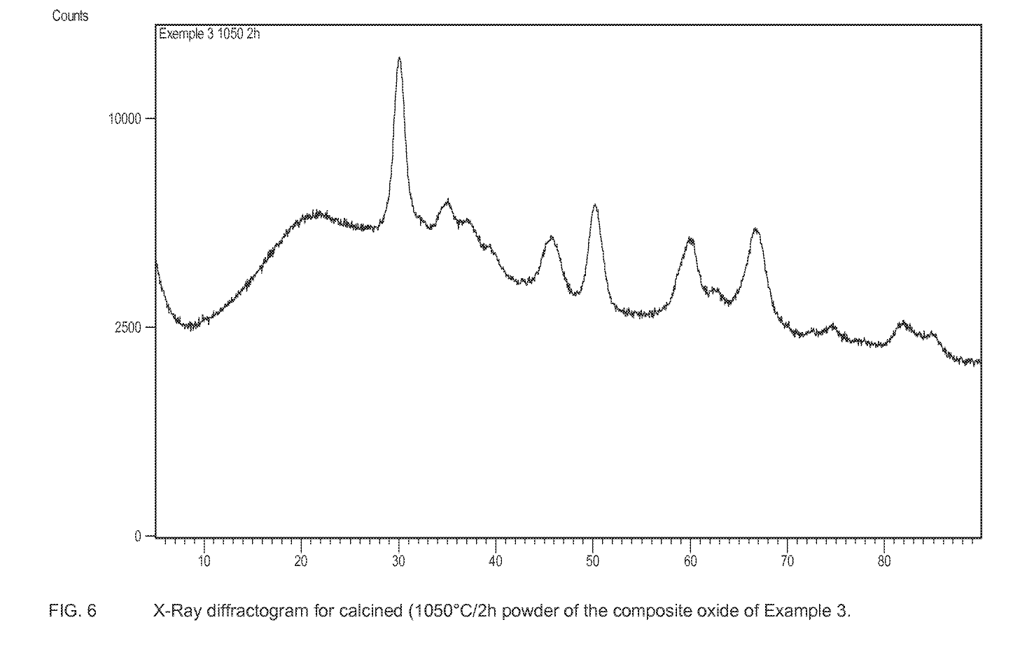

FIG. 5 shows a X-Ray diffractogram for the calcined (900° C./2 h) powder of the composite oxide of Example 3 and FIG. 6 shows a X-Ray diffractogram for the calcined (1050° C./2 h powder of the composite oxide of Example 3.

### Example 4

The composite oxide of Example 4 comprising, on the basis of 100 pbw of the composite oxide, 69 pbw Al₂O₃, 16 pbw SiO₂ and 13 pbw TiO₂ was made as in Example 2, except that titanyl orthosulfate (concentration 9.34%, density 1.376) was mixed with aluminum sulfate solution prior to precipitation. The spray dried powder exhibited a surface area of 488 m2/g. The spray dried powder was calcined at 750° C. for 2 hour and 900° C. for 2 hour. Samples of the powder that had been calcined at 750° C./2 h were then calcined at 1100° C. for 5 hours, at 1200° C. for 5 hours, and at 1050° C. for 2 hours. Results of surface area (in square meters per gram (“m²/g”)) and pore volume (in cubic centimeters per gram (“cm³/g”)), and average pore diameter (in nanometers (“nm”)) determinations are reported in TABLE IX below for each of the different calcination conditions.

TABLE IX

| Calcination | SA | Pore volume | Average pore |
|---|---|---|---|
| Temperature/time | (m²/g) | (cm³/g) | diameter (nm) |
| 750° C./2 h | 393 | 1.25 | 9 |
| 900° C./2 h | 320 | 1.17 | 10.0 |
| 1100° C./5 h | 141 | | |
| 1200° C./5 h | 24 | | |

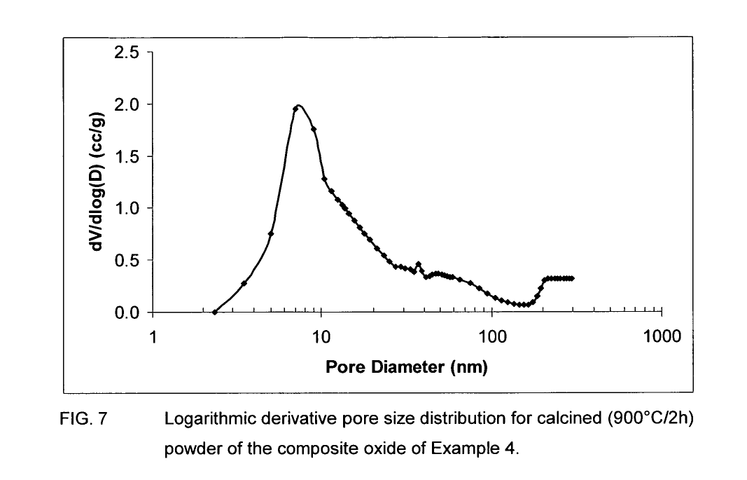

FIG. 7 shows a logarithmic derivative pore size distribution for calcined (900° C./2 h) powder of the composite oxide of Example 4.

X-Ray Diffactogram were collected between 2 theta=10 and 2 theta=90 for the powders calcined at different temperatures. Crystallite size for titanium dioxide was evaluated using the Debye Sherrer method. Results are reported in TABLE X below.

TABLE X

| Calcination | | TiO₂ Crystalite |
|---|---|---|
| Temperature/time | Crystaline phases | size (nm) |
| 750° C./2 h | TiO₂ anatase, gamma alumina | 7 |
| 900° C./2 h | TiO₂ anatase, gamma alumina | 9 |

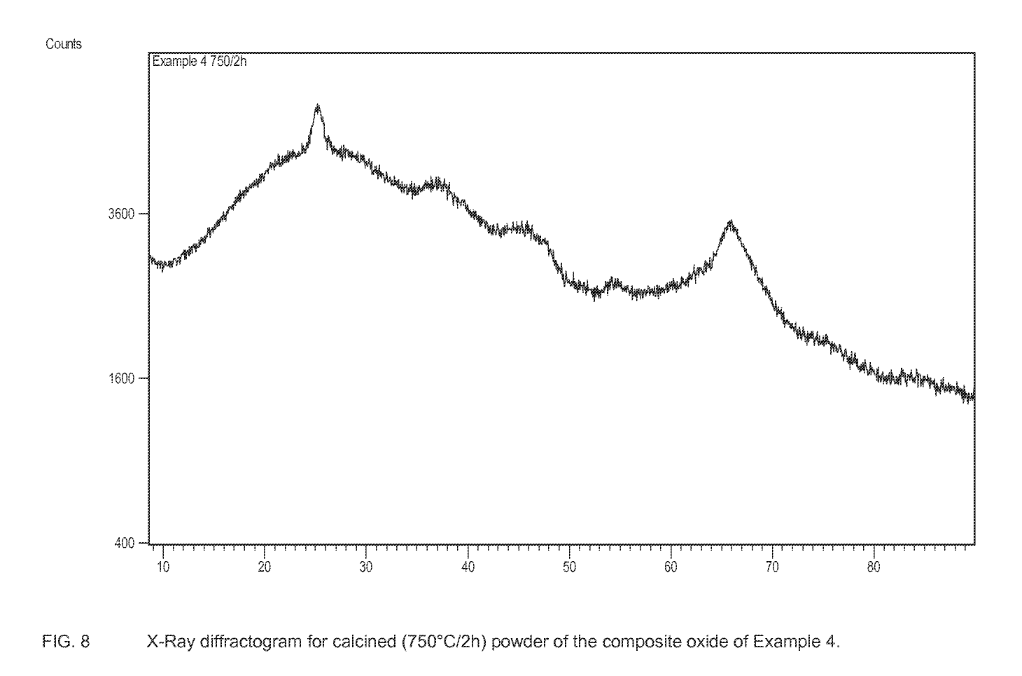

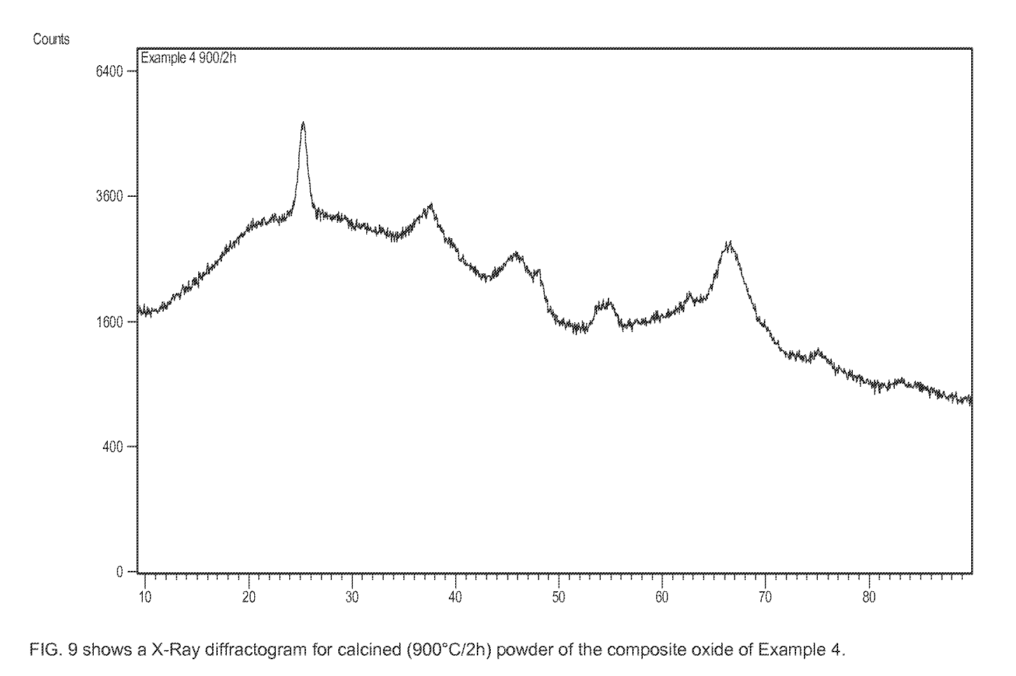

FIG. 8 shows a X-Ray diffractogram for calcined (750° C./2 h) powder of the composite oxide of Example 4 and FIG. 9 shows a X-Ray diffractogram for calcined (900° C./2 h) powder of the composite oxide of Example 4.

1. A method for making a sulfur tolerant alumina, comprising:
forming aluminum hydrate from one or more water soluble aluminum salts, said salts each comprising an aluminum cation or aluminum anion and an oppositely charged counterion, in an aqueous medium,
contacting the aluminum hydrate with a silica precursor in the aqueous medium and in the presence of counterions of the one or more aluminum salts,
isolating silica precursor-contacted aluminum hydrate particles from the aqueous medium, and
calcining the silica precursor-contacted aluminum hydrate particles to form particles of the sulfur tolerant alumina.

2. The method of claim 1, wherein the aluminum hydrate is made by reacting aluminum sulfate and sodium aluminate in an aqueous medium.

3. The method of claim 1, wherein the silica precursor is selected from alkali metal silicates and mixtures thereof.

4. The method of claim 1, wherein the aluminum hydrate is contacted with an amount of silica precursor sufficient to provide a silica clad alumina product having from a silica content of from about 1 to about 40 pbw silica.

5. The method of claim 1, wherein the aqueous medium containing aluminum hydrate and silica precursor is heated to a temperature of from about 50° C. to about 200° C. for a time period of from about 20 minutes to about 6 hours.

6. The method of claim 1, wherein the silica precursor-contacted aluminum hydrate particles are isolated from the aqueous medium by filtration.

7. The method of claim 1, further comprising washing the isolated silica precursor-contacted aluminum hydrate particles to remove water soluble residues from the particles.

8. The method of claim 7, wherein the washed particles are dewatered and then mixed with an aqueous medium to form an aqueous slurry.

9. The method of claim 8, wherein the aqueous slurry is spray dried to form silica precursor-contacted aluminum hydrate particles.

10. The method of claim 1, wherein the silica precursor-contacted aluminum hydrate particles are calcined at a temperature of from 400° to 1100° C., for greater than or equal to about 30 minutes.

11. The method of claim 1, further comprising doping the sulfur tolerant alumina with a dopant selected from transition metals, transition metal oxides, alkaline earths, alkaline earth oxides rare earths, rare earth oxides, and mixtures thereof by introducing a dopant or dopant precursor with the aluminum hydrate during formation of the aluminum hydrate and/or during the contacting of the silica precursor with the aluminum hydrate.

12. A sulfur tolerant alumina made according to claim 11, comprising a composite oxide comprising alumina, silica, and zirconia that exhibits improved phase stability.

13. A sulfur tolerant composite oxide comprising alumina, silica, and zirconia and exhibiting improved phase stability wherein, after calcining at 1050° C. for 2 hours, the zirconia is present as tetragonal zirconia only.

14. A sulfur tolerant alumina made according to claim 11, comprising a composite oxide of alumina, silica, and TiO₂, that exhibits improved phase stability.

15. A sulfur tolerant composite oxide comprising alumina, silica, and TiO₂, and exhibiting improved phase stability wherein, after calcining at 900° C. for 2 hours, the TiO₂ is present as anatase TiO₂ only.

16. The method of claim 1, further comprising mixing the sulfur tolerant alumina with other oxide support materials selected from alumina, magnesia, ceria, ceria-zirconia, rare-earth oxide-zirconia mixtures, and mixtures thereof.

17. A sulfur tolerant alumina made by the method of claim 1.

18. A catalyst, comprising a noble metal supported on a sulfur tolerant alumina according to claim 17.
